(19) United States
(12) Patent Application Publication
(10) Pub. No.: US 2024/0426681 A1
(43) Pub. Date: Dec. 26, 2024

(54) ELECTRIC CIRCUIT BODY AND ELECTRONIC DEVICE

(71) Applicants: HONDA MOTOR CO., LTD., Tokyo (JP); The University of British Columbia, Vancouver (CA)

(72) Inventors: Ryusuke Ishizaki, Wako-shi (JP); Takeshi Osato, Wako-shi (JP); Fumiya Hamatsu, Wako-shi (JP); Jian Gao, Vancouver (CA); John D.W. Madden, Vancouver (CA); Xiulun Yin, Vancouver (CA); Yizhong Chen, Vancouver (CA); Nischay Joshi, Vancouver (CA)

(21) Appl. No.: 18/736,584

(22) Filed: Jun. 7, 2024

(30) Foreign Application Priority Data
Jun. 26, 2023 (JP) 2023-104454

(51) Int. Cl. G01L 1/14

(52) U.S. Cl. CPC G01L 1/146

(57) ABSTRACT

An electric circuit body includes: a plurality of sensor cells integrally aligned; one or more terminal portions (a first terminal portion and a second terminal portion); and a conductor wire (a first conductor wire and a second conductor wire). Each terminal portion includes a plurality of terminals connected to the plurality of sensor cells. The conductor wire connects the plurality of terminals and the plurality of sensor cells. The plurality of sensor cells are separated into a first cell group connected to a predetermined terminal portion (for example, a first terminal portion) and a second cell group disconnected from the predetermined terminal portion by cutting the plurality of conductor wires at an appropriate position.

### CROSS-REFERENCE TO RELATED APPLICATION

Priority is claimed on Japanese Patent Application No. 2023-104454, filed on Jun. 26, 2023, the contents of which are incorporated herein by reference.

### BACKGROUND

### Field of the Invention

The present invention relates to an electric circuit body and an electronic device.

### Background

In the related art, a flexible capacitance sensor that includes a pair of electrodes sandwiching a dielectric which elastically deforms from both sides in a thickness direction is known (for example, refer to Japanese Unexamined Patent Application, First Publication No. 2022-105964).

### SUMMARY

For example, a sensor array that includes a plurality of sensor cells integrally aligned in a regular manner such as a sensor device or the like that is attached to or worn on a human body or a robot may be individually designed and manufactured in accordance with a condition such as a shape of an arrangement location, a required number of sensor cells, and the like. However, a problem occurs in that the individual design and manufacture are complicated and require time and effort, resulting in an increase in costs.

An aspect of the present embodiment aims at providing an electric circuit body and an electronic device that can improve versatility.

An electric circuit body according to a first aspect of the present invention includes: a plurality of integrally aligned cells having a predetermined function; one or more terminal portions having a plurality of terminals connected to the plurality of cells; and a plurality of conductor wires that connect the plurality of terminals and the plurality of cells, wherein the plurality of cells are separated into a first cell group connected to one terminal portion among the one or more terminal portions and a second cell group disconnected from the one terminal portion by cutting the plurality of conductor wires at an appropriate position.

A second aspect is the electric circuit body according to the first aspect described above, wherein the conductor wire disconnected from the cell among the plurality of conductor wires may be set to a reference potential.

An electronic device according to a third aspect of the present invention includes: the electric circuit body according to the second aspect described above; and a reference potential-setting portion that is connected to the one terminal portion and sets the conductor wire disconnected from the cell to the reference potential.

A fourth aspect is the electronic device according to the third aspect described above which may include: a connection switch portion that is connected to the one terminal portion and performs connection to one conductor wire among the plurality of conductor wires which is selected by sequential switching from the plurality of conductor wires connected to the one terminal portion; and a process portion that prohibits the conductor wire disconnected from the cell from being selected by the connection switch portion and setting the conductor wire prohibited from being selected by the connection switch portion to the reference potential by the reference potential-setting portion.

A fifth aspect is the electronic device according to the fourth aspect described above, wherein each of the plurality of cells may include: a first electrode and a second electrode that are arranged to be spaced from each other; and an elastic base material that has a dielectric property or a conductive property and is arranged between the first electrode and the second electrode, the process portion may detect, via the connection switch portion, a capacitance or an electric resistance between the first electrode and the second electrode of each cell corresponding to each conductor wire connected to the one terminal portion, and when the capacitance is less than a predetermined threshold capacity, or the electric resistance is larger than a predetermined threshold resistance, it may be determined that the conductor wire selected by the connection switch portion is abnormal, and the abnormal conductor wire may be set to the reference potential.

According to the first aspect described above, since the plurality of cells are separated into the first cell group connected to a desired terminal portion and the second cell group disconnected from the desired terminal portion, it is possible to easily change the shape and the number of cells of the first cell group as needed. For example, it is possible to reduce the time, effort and costs, and improve versatility compared to the case in which individual design and manufacturing are performed in accordance with various conditions such as a shape of an arrangement location, a required number of cells, and the like.

In the case of the second aspect described above, since the conductor wire disconnected from the cell is set to the reference potential, for example, it is possible to prevent the conductor wire that is not connected to any cell from becoming an antenna and becoming susceptible to noise.

According to the third aspect described above, by including the reference potential-setting portion, for example, it is possible to easily prevent the conductor wire that is not connected to any cell from becoming an antenna and becoming susceptible to noise.

In the case of the fourth aspect described above, by including the connection switch portion, it is possible to sequentially switch the connection and disconnection to the plurality of conductor wires, and therefore, the process portion can detect the presence or absence of connection with the conductor wire for each of the plurality of cells by the connection switch portion. Since the process portion prohibits the conductor wire disconnected from the cell from becoming a selection target of connection by the connection switch portion, it is possible to prevent unnecessary power distribution or the like from being performed. Since the process portion sets the conductor wire disconnected from the cell to the reference potential by the reference potential-setting portion, it is possible to prevent the conductor wire disconnected from the cell from becoming susceptible to noise.

In the case of the fifth aspect described above, the process portion can detect the presence or absence of an abnormality of each conductor wire, for example, at the time of starting, at the time of operation, and the like, can dynamically update the selection target of connection by the connection switch portion, and can appropriately prevent the increase of noise.

### BRIEF DESCRIPTION OF THE DRAWINGS

FIG. 1 is a configuration view of an electronic device including an electric circuit body in an embodiment of the present invention.

FIG. 2 is a cross-sectional view showing a configuration of a sensor cell of the electric circuit body in the embodiment of the present invention.

FIG. 3 is a configuration view of the electronic device including a separated electric circuit body in the embodiment of the present invention.

FIG. 4 is a cross-sectional view showing a configuration of a sensor cell in a modification example of the embodiment of the present invention.

### DESCRIPTION OF EMBODIMENTS

Hereinafter, an electric circuit body and an electronic device according to an embodiment of the present invention will be described with reference to the attached drawings.

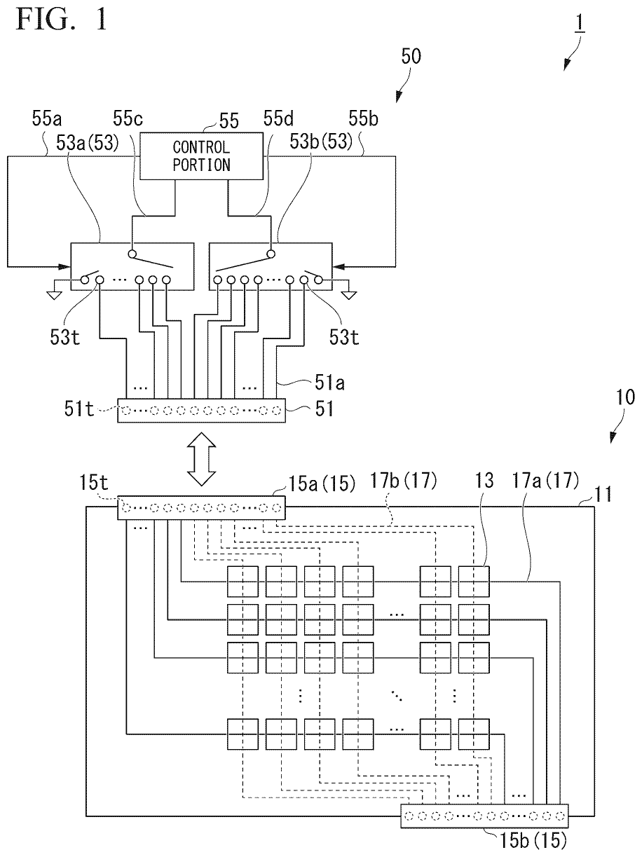

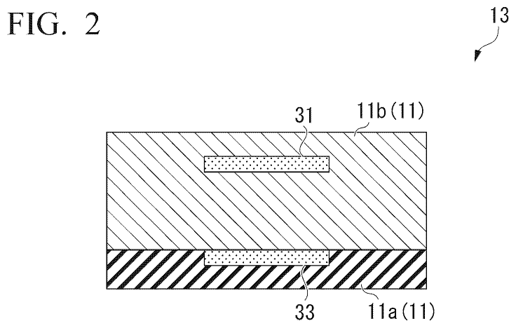

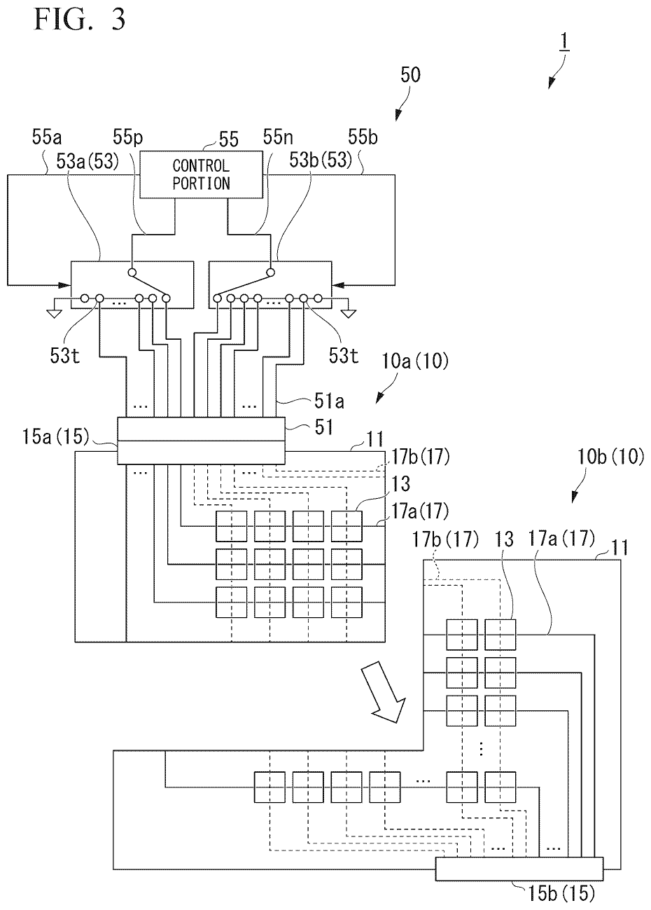

FIG. 1 is a configuration view of an electronic device 1 including an electric circuit body 10 in an embodiment. FIG. 2 is a cross-sectional view showing a configuration of a sensor cell 13 in the electric circuit body 10 of the embodiment. FIG. 3 is a configuration view of the electronic device 1 including a separated electric circuit body 10 in the embodiment.

The electronic device 1 of the embodiment is, for example, a flexible circuit device (flexible and stretchable circuit device) that includes the electric circuit body 10 attached to or worn on a human body or a robot and having flexibility and a stretch property.

As shown in FIG. 1, the electric circuit body 10 includes, for example, a flexible circuit substrate 11, a plurality of sensor cells 13, one or more terminal portions 15, and a plurality of conductor wires 17.

The flexible circuit substrate 11 includes, for example, a substrate 11a and a base material 11b (elastic base material).

The substrate 11a is formed of, for example, a flexible insulator such as a so-called flexible substrate.

The base material 11b is fixed on a surface of the substrate 11a by adhesion or the like. The base material 11b is formed of, for example, a flexible dielectric such as a so-called thermosetting elastomer.

The flexible circuit substrate 11 is separated into a plurality of portions by being cut together with the conductor wire 17 at an arbitrary position between each terminal portion 15 and the plurality of sensor cells 13 described later as needed.

The plurality of sensor cells 13 are integrally aligned in a regular manner in the flexible circuit substrate 11. The plurality of sensor cells 13 are aligned, for example, in a matrix form when seen from a thickness direction of the flexible circuit substrate 11. Each of the plurality of sensor cells 13 is, for example, a capacitance-type uniaxial force sensor.

As shown in FIG. 2, each of the plurality of sensor cells 13 is constituted of, for example, a first electrode 31 and a second electrode 33 that are arranged to be spaced from each other, and a base material 11b between the first electrode 31 and the second electrode 33.

The first electrode 31 and the second electrode 33 are formed of, for example, a conductive material having flexibility and a stretch property such as a resin including a conductive metal filler. Outer shapes of the first electrode 31 and the second electrode 33 are, for example, a rectangular plate shape having the same size. The first electrode 31 is supported by the base material 11b. The second electrode 33 is supported by the substrate 11a. The first electrode 31 and the second electrode 33 are arranged, for example, so as to face each other via part of the base material 11b in the thickness direction of the flexible circuit substrate 11.

Each sensor cell 13 outputs, for example, a signal relating to a change of a capacitance due to deformation of the base material 11b between the first electrode 31 and the second electrode 33 caused by an action of an external force.

As shown in FIG. 1, the one or more terminal portions 15 are, for example, two terminal portions 15 (that is, a first terminal portion 15a and a second terminal portion 15b). Each terminal portion 15 is attached to and detached from a connection portion 51 of a process device 50 described later, and thereby, mutual connection and disconnection are switched. Each terminal portion 15 is, for example, a male or female connector which forms a pair with the connection portion 51 of the process device 50. The first terminal portion 15a and the second terminal portion 15b are, for example, arranged at opposing corner portions of the flexible circuit substrate 11 having a rectangular plate shape.

Each terminal portion 15 includes, for example, a plurality of terminals 15t connected to the first electrode 31 and the second electrode 33 of each of the plurality of sensor cells 13. The number of terminals 15t of each terminal portion 15 is, for example, the sum of the number of rows and the number of columns of the plurality of sensor cells 13 aligned in a matrix form.

Each of the plurality of conductor wires 17 is formed of, for example, a conductive material having flexibility and a stretch property such as a resin including a conductive metal filler. The plurality of conductor wires 17 are, for example, a plurality of first conductor wires 17a arranged along a row direction of the plurality of sensor cells 13 aligned in the matrix form and a plurality of second conductor wires 17b arranged along a column direction. The number of the plurality of first conductor wires 17a is the number of rows of the plurality of sensor cells 13 aligned in the matrix form. The number of the plurality of second conductor wires 17b is the number of columns of the plurality of sensor cells 13 aligned in the matrix form.

Each first conductor wire 17a connects, for example, each terminal 15t of each terminal portion 15 to the first electrode 31 of the plurality of sensor cells 13 in each row. Each second conductor wire 17b connects, for example, each terminal 15t of each terminal portion 15 to the second electrode 33 of the plurality of sensor cells 13 in each column.

As shown in FIG. 3, each conductor wire 17 is separated into a plurality of portions by being cut together with the flexible circuit substrate 11 at an arbitrary position between the plurality of sensor cells 13 and each terminal portion 15 as needed. A portion of each conductor wire 17 separated from any sensor cell 13 by cutting is set to a reference potential by a connection switch portion 53 (reference potential-setting portion) described later.

For example, in an example shown in FIG. 3, by cutting at an appropriate position of the flexible circuit substrate 11 and the plurality of conductor wires 17, the electric circuit body 10 is separated into a first electric circuit body 10a including a first cell group of the plurality of sensor cells 13 connected to the first terminal portion 15a and a second electric circuit body 10b including a second cell group of the plurality of sensor cells 13 connected to the second terminal portion 15b.

As shown in FIG. 1, the electronic device 1 includes the process device 50 connected to the electric circuit body 10.

The process device 50 includes, for example, the connection portion 51, two connection switch portions 53, and a control portion 55 (process portion).

The connection portion 51 is attached to and detached from the terminal portion 15 of the electric circuit body 10, and thereby, mutual connection and disconnection are switched. The connection portion 51 is, for example, a male or female connector which forms a pair with the terminal portion 15 of the electric circuit body 10.

The connection portion 51 includes, for example, a plurality of terminals 51t connected to two connection switch portions 53 by a plurality of wirings 51a. The number of terminals 51t of the connection portion 51 is, for example, the same as the number of terminals 15t of the terminal portion 15 of the electric circuit body 10, and is the sum of the number of rows and the number of columns of the plurality of sensor cells 13 aligned in the matrix form.

The two connection switch portions 53 are, for example, a first connection switch portion 53a (reference potential-setting portion) and a second connection switch portion 53b (reference potential-setting portion). The first connection switch portion 53a is provided so as to correspond to a row of the plurality of sensor cells 13 aligned in the matrix form. The second connection switch portion 53b is provided so as to correspond to a column of the plurality of sensor cells 13 aligned in the matrix form. Each connection switch portion 53 includes, for example, a plurality of terminals 53t in which alternative selections are sequentially switched. Each connection switch portion 53 sets, for example, any one terminal 53t selected by sequential switching from the plurality of terminals 53t as a selection target to be in a connection state, and sets another terminal 53t to a reference potential by grounding or the like. Each connection switch portion 53 constantly sets, for example, the terminal 53t selected other than the selection target of the connection state to the reference potential by grounding or the like. Among the plurality of terminals 53t of each connection switch portion 53, the terminal 53t as the selection target of the connection state and the terminal 53t as a terminal other than the selection target are commanded, for example, by the control portion 55 described later.

The first connection switch portion 53a selectively switches connection to any one of the rows of the plurality of sensor cells 13 aligned in the matrix form, that is, the plurality of first conductor wires 17a in response to a command of the control portion 55 described later. The second connection switch portion 53b selectively switches connection to any one of the columns of the plurality of sensor cells 13 aligned in the matrix form, that is, the plurality of second conductor wires 17b in response to a command of the control portion 55 described later.

The control portion 55 is, for example, a software function unit that functions by a predetermined program being executed by a processor such as a CPU (Central Processing Unit). The software function unit is an ECU that includes the processor such as a CPU, a ROM (Read-Only Memory) that stores the program, a RAM (Random-Access Memory) that temporarily stores data, and an electronic circuit such as a timer. At least part of the control portion 55 may be an integrated circuit such as a LSI (Large-Scale Integration).

The control portion 55 is connected to each of the first connection switch portion 53a and the second connection switch portion 53b, for example, by a pair of first signal lines 55a, 55b and a pair of second signal lines 55c, 55d.

The pair of first signal lines 55a, 55b transmit, for example, to each of the first connection switch portion 53a and the second connection switch portion 53b, a signal that commands selection switching of one terminal 53t that is set to the connection state among the plurality of terminals 53t and selection of the terminal 53t that is not set to the connection state and is set to the reference potential. Each one terminal 53t that is set to the connection state by each connection switch portion 53a, 53b is each terminal 53t connected to the first electrode 31 and the second electrode 33 of the same sensor cell 13. The terminal 53t that is not set to the connection state and is set to the reference potential is, for example, a terminal 53t that is excluded from the alternative selection depending on the timing among the selection targets of the connection state, and a terminal 53t that is other than the selection target of the connection state (that is, selection is prohibited) and is constantly set to the reference potential. The terminal 53t that is other than the selection target of the connection state is, for example, a terminal 53t separated from any sensor cell 13 by cutting of the flexible circuit substrate 11 and the conductor wire 17 in accordance with the necessity, a terminal 53t in which an abnormality such as disconnection from the sensor cell 13 is detected, and the like.

The pair of second signal lines 55c, 55d transmit, for example, to each sensor cell 13, an input signal and an output signal for detecting the capacitance via each of the first connection switch portion 53a and the second connection switch portion 53b.

The control portion 55 detects the capacitance of each sensor cell 13, for example, on the basis of the input signal and the output signal to each sensor cell 13 that sets the connection state alternatively a predetermined cycle. The control portion 55 detects, for example, a change of the capacitance due to deformation of the base material 11b between the first electrode 31 and the second electrode 33 of each sensor cell 13 caused by an action of an external force. The control portion 55 detects a magnitude, distribution, and the like of the external force in a uniaxial direction that acts on each sensor cell 13 on the basis of the change of the capacitance of each sensor cell 13.

For example, when the capacitance of one sensor cell 13 is less than a predetermined threshold value, the control portion 55 determines that the one sensor cell 13 has been separated from the terminal portion 15 (predetermined terminal portion 15) connected to the connection portion 51, or that an abnormality such as disconnection between the one sensor cell 13 and each connection switch portion 53a, 53b has occurred. The predetermined threshold value is, for example, a predetermined value or the like that is smaller than the capacitance of the sensor cell 13 in an unloaded state on which the external force does not act.

The control portion 55 determines the presence or absence of separation of the sensor cell 13 caused by cutting or the like and recognizes a region (connection region) in which the sensor cell 13 connected to the predetermined terminal portion 15 is present, for example, by detecting the presence or absence of a sensor cell 13 having a capacitance that is less than the predetermined threshold value at the time of starting of the electronic device 1 or the like. For example, the control portion 55 sets only the sensor cell 13 included in the connection region to the selection target of the connection state by the connection switch portion 53. The control portion 55 detects the presence or absence of occurrence of an anomaly such as disconnection in the connection region recognized at the time of starting or the like, for example, by detecting the presence or absence of the sensor cell 13 having a capacitance that is less than the predetermined threshold value at the time of operation of the electronic device 1 or the like. The control portion 55 updates the connection region when an abnormal sensor cell 13 is newly detected in the connection region.

As described above, according to the electric circuit body 10 of the embodiment, since the plurality of sensor cells 13 are separated into the first cell group connected to a desired terminal portion 15 and the second cell group disconnected from the desired terminal portion 15, it is possible to easily change the shape and the number of cells of the first cell group as needed. For example, it is possible to reduce the time, effort and costs, and improve versatility compared to the case in which individual design and manufacturing are performed in accordance with various conditions such as a shape of an arrangement location, a required number of cells, and the like.

Since the conductor wire 17 disconnected from any sensor cell 13 is set to the reference potential, for example, it is possible to prevent the conductor wire 17 that is not connected to any sensor cell 13 from becoming an antenna and becoming susceptible to noise.

According to the electronic device 1 of the embodiment, by including the connection switch portion 53, for example, it is possible to easily prevent the conductor wire 17 that is not connected to any sensor cell 13 from becoming an antenna and becoming susceptible to noise.

By the connection switch portion 53, it is possible to sequentially switch the connection and disconnection to the plurality of conductor wires 17, and therefore, the control portion 55 can detect the presence or absence of connection with the conductor wire 17 for each of the plurality of sensor cells 13 by the connection switch portion 53. Since the control portion 55 prohibits the conductor wire 17 disconnected from the sensor cell 13 from becoming a selection target of connection by the connection switch portion 53, it is possible to prevent unnecessary power distribution or the like from being performed. Since the control portion 55 sets the conductor wire 17 disconnected from the sensor cell 13 to the reference potential by the connection switch portion 53, it is possible to prevent the conductor wire 17 disconnected from the sensor cell 13 from becoming susceptible to noise.

The control portion 55 can detect the presence or absence of an abnormality of each sensor cell 13 and each conductor wire 17, for example, at the time of starting, at the time of operation, and the like, can dynamically update the selection target of the connection state by the connection switch portion 53, and can appropriately prevent the increase of noise.

### Modification Example

Hereinafter, a modification example of the embodiment is described. The same portions as those of the embodiment described above are denoted by the same reference numerals, and descriptions thereof are omitted or simplified.

The above embodiment is described using an example in which the plurality of sensor cells 13 are aligned in a matrix form when seen from the thickness direction of the flexible circuit substrate 11; however, the embodiment is not limited thereto. For example, when seen from the thickness direction of the flexible circuit substrate 11, the arrangement of the plurality of sensor cells 13 is not limited to an alignment in rows and columns that are orthogonal to each other, and the plurality of sensor cells 13 may be appropriately aligned regularly, for example, such that the plurality of sensor cells 13 are aligned along rows and columns that appropriately intersect one another obliquely, are aligned on a circumference of a concentric circle, or are aligned on an appropriate graphic.

The above embodiment is described using an example in which each sensor cell 13 is a capacitance-type uniaxial force sensor; however, the embodiment is not limited thereto. For example, each sensor cell 13 may be a capacitance-type multiaxial force sensor such as a triaxial force sensor.

The above embodiment is described using an example in which each sensor cell 13 is a capacitance-type uniaxial force sensor; however, the embodiment is not limited thereto. For example, each sensor cell 13 may be an electric resistance-type force sensor.

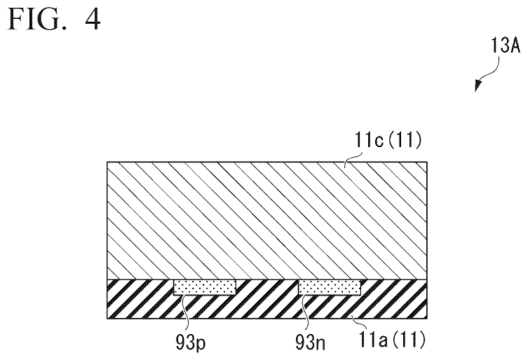

FIG. 4 is a cross-sectional view showing a configuration of a sensor cell 13A in a modification example of the embodiment.

As shown in FIG. 4, the sensor cell 13A of the modification example is constituted of, for example, a pressure-sensitive resistive base material 11c (elastic base material) provided instead of the base material 11b in the embodiment, and a positive-side electrode 93p (first electrode) and a negative-side electrode 93n (second electrode) that are supported by a substrate 11a. The sensor cell 13A of the modification example is, for example, an electric resistance-type uniaxial force sensor.

Each sensor cell 13A of the modification example outputs, for example, a signal relating to a change of an electric resistance of the base material 11c between the positive-side electrode 93p and the negative-side electrode 93n caused by an action of an external force.

The control portion 55 of the modification example detects a magnitude, distribution, and the like of the external force in a uniaxial direction that acts on each sensor cell 13 on the basis of the change of the electric resistance of each sensor cell 13. The control portion 55 determines the presence or absence of separation of the sensor cell 13A caused by cutting or the like and recognizes a region (connection region) in which the sensor cell 13A connected to the predetermined terminal portion 15 is present, for example, by detecting the presence or absence of a sensor cell 13A having an electric resistance that is larger than a predetermined threshold value.

The above embodiment is described using an example in which the electric circuit body 10 includes a plurality of sensor cells 13; however, the embodiment is not limited thereto. For example, the electric circuit body 10 may include a plurality of cells having another predetermined function other than a sensor, such as a tactile stimulation cell of electricity or the like or an actuator cell of vibration or the like, instead of the sensor cell 13.

The above embodiment is described using an example in which the electric circuit body 10 includes a flexible circuit substrate 11 having a flexible substrate 11a and a base material 11b; however, the embodiment is not limited thereto. For example, the electric circuit body 10 is not limited to a flexible base body (an insulator, a dielectric, and the like) and may be formed of another base body (an insulator, a dielectric, and the like). For example, the electric circuit body 10 may include various circuit substrates such as a so-called rigid substrate, a flexible substrate, a rigid flexible substrate, or a substrate having a stretch property. For example, the rigid substrate includes a base body that does not have flexibility. The flexible substrate includes a base body that has flexibility. The rigid flexible substrate includes a composite body of a base body that does not have flexibility and a base body that has flexibility. The substrate having a stretch property includes, for example, a base body having a stretch property such as an elastomer. As described above, the various circuit substrates are not limited to a rigid base body having a plate form and may include, for example, various base bodies of a thin film form or the like having at least one of flexibility and a stretch property. The electric circuit body 10 may be, for example, an electronic component in which a wiring, an electronic component, and the like are arranged directly on various base bodies.

The embodiments of the present invention have been presented as examples and are not intended to limit the scope of the invention. The embodiments can be implemented in a variety of other modes, and various omissions, substitutions, and modifications can be made without departing from the scope of the invention. The embodiments and modifications thereof are included within the scope and gist of the invention and are also included within the scope of the invention described in the appended claims and equivalents thereof.

What is claimed is:

1. An electric circuit body, comprising:
a plurality of integrally aligned cells having a predetermined function;
one or more terminal portions having a plurality of terminals connected to the plurality of cells; and
a plurality of conductor wires that connect the plurality of terminals and the plurality of cells,
wherein the plurality of cells are separated into a first cell group connected to one terminal portion among the one or more terminal portions and a second cell group disconnected from the one terminal portion by cutting the plurality of conductor wires at an appropriate position.

2. The electric circuit body according to claim 1,
wherein the conductor wire disconnected from the cell among the plurality of conductor wires is set to a reference potential.

3. An electronic device comprising:
the electric circuit body according to claim 2; and
a reference potential-setting portion that is connected to the one terminal portion and sets the conductor wire disconnected from the cell to the reference potential.

4. The electronic device according to claim 3, comprising:
a connection switch portion that is connected to the one terminal portion and performs connection to one conductor wire among the plurality of conductor wires which is selected by sequential switching from the plurality of conductor wires connected to the one terminal portion; and
a process portion that prohibits the conductor wire disconnected from the cell from being selected by the connection switch portion and setting the conductor wire prohibited from being selected by the connection switch portion to the reference potential by the reference potential-setting portion.

5. The electronic device according to claim 4,
wherein each of the plurality of cells comprises: a first electrode and a second electrode that are arranged to be spaced from each other; and an elastic base material that has a dielectric property or a conductive property and is arranged between the first electrode and the second electrode,
the process portion detects, via the connection switch portion, a capacitance or an electric resistance between the first electrode and the second electrode of each cell corresponding to each conductor wire connected to the one terminal portion, and
when the capacitance is less than a predetermined threshold capacity, or the electric resistance is larger than a predetermined threshold resistance, it is determined that the conductor wire selected by the connection switch portion is abnormal, and the abnormal conductor wire may be set to the reference potential.
